(19) United States
(12) Patent Application Publication
(10) Pub. No.: US 2022/0203441 A1
(43) Pub. Date: Jun. 30, 2022

(54) METHOD FOR MANUFACTURING A PIPE FOR A PIPELINE AND A PIPE

(71) Applicant: TEKNOLOGIAN TUTKIMUSKESKUS VTT OY, ESPOO (FI)

(72) Inventors: Tero VÄLISALO, Tampere (FI); Pasi PUUKKO, VTT (FI); Sini METSÄ-KORTELAINEN, VTT (FI); Timo KINOS, Tampere (FI); Teuvo SILLANPÄÄ, Tampere (FI); Jari HALME, VTT (FI)

(21) Appl. No.: 17/605,813

(22) PCT Filed: Apr. 22, 2020
(86) PCT No.: PCT/FI2020/050260

§ 371 Date: Oct. 22, 2021

(30) Foreign Application Priority Data
Apr. 24, 2019 (FI) 20195324

(51) Int. Cl. B22F 5/10; B22F 10/28; F16L 9/02; G01F 1/66; G01N 29/24; B33Y 10/00; B33Y 70/00; B33Y 80/00

(52) U.S. Cl. CPC B22F 5/106; B22F 10/28; F16L 9/02; G01F 1/662; G01N 2291/102; B33Y 10/00; B33Y 70/00; B33Y 80/00; G01N 2291/045; G01N 29/2475

(57) ABSTRACT

Method for manufacturing a pipe for a pipeline, wherein at least part of the pipe is manufactured by additive manufacturing process, wherein at least one space for an ultrasonic transducer is formed inside the material of the pipe during the additive manufacturing process. The additive manufacturing process is interrupted before the space in closed, and the ultrasonic transducer is inserted in the open space, and the additive manufacturing process for manufacturing the pipe is continued. The invention also relates to such a pipe.

### CROSS-REFERENCE TO RELATED APPLICATIONS

This is a U.S. national application of the international application number PCT/FI2020/050260 filed on Apr. 22, 2020, and claiming priority of FI 20195324 filed on Apr. 24, 2019, the contents of both of which are incorporated herein by reference.

### FIELD OF INVENTION

The present invention relates to a method for manufacturing a pipe for a pipeline, which pipe can provide information for the condition of the pipeline continuously or periodically, and to such a pipe providing this kind of monitoring option.

### BACKGROUND OF THE INVENTION

There is generally a great and increasing need for water pipeline rehabilitations, especially in western countries, where the pipelines are often over 60 years old. Nowadays these renovation decisions are made according to the age and material of the pipes, and not the actual condition of the pipework, since this condition information is not available.

Further, the costs for fixing broken pipelines are much greater, both economically and timewise, than planned and scheduled maintenance and upkeep of pipelines based on actual condition data.

Also, the water usage is presently typically measured only in the place of water consumption, which leads to that in a water distribution network there are only few measuring points, which is not sufficient for an effective water leakage detection.

Thus, there is a need for an implementation or a solution for measuring liquid amounts passing through the pipeline, which can be utilized for collecting condition data of pipelines. Further, since the pipelines are often located underground, the collected data should also be easily accessible.

### SUMMARY OF THE INVENTION

The present invention provides a solution for collecting data from water or liquid amounts passing in the pipeline, which solution is integrated in a pipe itself and can thus be easily placed anywhere on the pipeline. Further, the solution of the invention can also provide the data for analysis substantially continuously.

In the method of the invention for manufacturing a pipe for a pipeline, wherein at least part of the pipe is manufactured by additive manufacturing process, at least one space for an ultrasonic transducer is formed inside the material of the pipe during the additive manufacturing process, the additive manufacturing process is interrupted before the said space is closed, the ultrasonic transducer is inserted in the said open space, and the additive manufacturing process for manufacturing the pipe is continued, which continued additive manufacturing process covers the said space.

This way the ultrasonic transducer can be placed inside the material of the pipe without causing it to be excessively heated, and the proper positioning of the ultrasonic transducer in relation to the inner area of the pipe can be guaranteed.

In an embodiment of the method of the invention the space for the ultrasonic transducer is covered with a lid after inserting to the ultrasonic transducer and before continuing the additive manufacturing process. The lid is preferably made of a metal material, and may be manufactured from the same material as the pipe and simultaneously with the pipe with the same additive manufacturing process.

In an embodiment of the method of the invention two longitudinally displaced spaces are formed along the length of the pipe for two ultrasonic transducers. Alternatively, in this embodiment, the space for a second ultrasonic transducer can be formed as an open space in the end of the pipe, in the area of a pipe connection, so that the second space is closed when a next pipe is connected to the pipe with the transducers.

In an embodiment of the method of the invention at least one acoustic reflector is formed in the inner surface of the pipe with the additive manufacturing process of the pipe. Preferably the at least one acoustic reflector is formed in a recess on the inner surface of the pipe.

In an embodiment of the method of the invention the material of the pipe is metal, preferably steel, and more preferably AISI 316L steel.

In an embodiment of the method of the invention the additive manufacturing process is powder bed fusion process, such as direct metal laser sintering (DMLS), selective laser melting (SLM) or selective laser sintering (SLS).

The present invention also provides a pipe for a pipeline comprising an inner surface and an outer surface, and at least one ultrasonic transducer embedded inside the material of the pipe during the additive manufacturing process.

In an embodiment of the pipe of the invention the pipe comprises two ultrasonic transducers embedded inside the material of the pipe.

In an embodiment of the pipe of the invention the pipe comprises at least one acoustic reflector formed from the material of the pipe on the inner surface of the pipe. In this embodiment the at least one acoustic reflector is preferably located at least partially in a recess of the inner surface of the pipe.

In an embodiment of the pipe of the invention the pipe comprises suitable data transmitting means, such as a radio and an antenna, for transmitting the measurement data from the at least one ultrasonic transducer, and/or controlling means, such as a microcontroller unit (MCU), for controlling the at least one ultrasonic transducer. Further, the required wiring and electronic connections for these means are preferably integrated in the pipe.

More precisely the features defining a method for manufacturing a pipe and the pipe in accordance with the present invention are presented in the independent claims. Dependent claims present advantageous features and embodiments of the invention.

Exemplifying embodiment of the invention and its advantages are explained in greater detail below in the sense of example and with reference to accompanying drawing.

### BRIEF DESCRIPTION OF THE DRAWINGS

FIG. 1 shows schematically a cross-section of an embodiment of a pipeline part in accordance with the present invention.

### DETAILED DESCRIPTION OF THE INVENTION

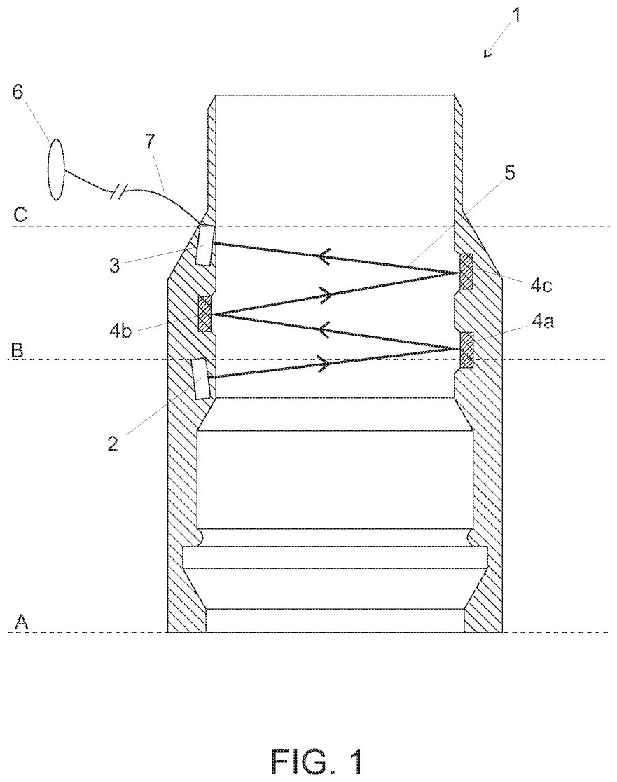

In FIG. 1 is shown a DN75 tube for socket joint 1 which is manufactured with powder bed fusion additive manufacturing process starting from the plane A and proceeding upwards. The material of the socket joint 1 is AISI 316L stainless steel.

During the additive manufacture process, when the process proceeds to plane B, the manufacturing process is interrupted, and an ultrasonic transducer 2 is inserted in a space formed inside the material wall of the manufactured socket joint 1. After inserting and proper positioning of the ultrasonic transducer 2, which in this embodiment is a transmitter, the open place for the transducer is closed with a lid, and the additive manufacturing process is continued until plane C is reached.

At the plane C the additive manufacturing process in interrupted again, and second ultrasonic transducer 3, which in this embodiment in a receiver, is inserted in a space formed inside the material wall of the manufactured socket joint 1. After inserting and proper positioning of the second ultrasonic transducer 3, which in this embodiment is a transmitter, the open place for the transducer is closed with a lid, and the additive manufacturing process is continued until the whole socket joint 1 in ready.

The lids used for closing the formed open spaces within the walls of the socket joint 1 can be made from suitable metal plates, for example. The lids may also be manufactured simultaneously with the socket joint 1 and with the same manufacturing process, and then added to the socket joint during the interruption of the manufacturing process. The function of the lids is to provide suitable surface for the continued powder bed fusion process, so the material of the lids needs to be able to withstand the required temperatures for this process. Further insulation material may be inserted into the formed spaces together with the ultrasonic transducers for protecting and/or properly positioning the transducers within the formed space, for example.

During the additive manufacturing process of the socket joint 1, three acoustic reflectors 4a-4c are formed in the inner surface of the socket joint. These reflectors 4a-4c are in this embodiment located in recesses formed in the inner surface of the socket joint 1. This way the reflectors do not significantly hinder the fluid flow inside the socket joint.

Further, the acoustic reflectors 4a-4c do not require any further finishing actions after the additive manufacturing process, since the surface quality achieved during this manufacturing process is sufficient. Also, at their simplest form the acoustic reflectors can be suitably directed and positioned surfaces, even though they are shown in the figures as separate structural entities.

With the acoustic reflectors 4a-4c the length of the ultrasonic measurement beam 5 from the transmitter 2 to the receiver 3 is extended so that the accuracy of the ultrasonic measurement is improved.

In relation to the embodiment shown in FIG. 1 and the measurement beam 5, it is to be noted, that the places of the ultrasonic transmitter 2 and receiver 3 can be changed so that the measurement beam 5 proceeds to opposite direction. Further, the ultrasonic transmitter 2 and receiver 3 can both be replaced with ultrasonic transceivers, wherein both transceivers operate both as a transmitter and as a receiver, so that the measurement beam 5 is bounced between the transceivers, for example.

In the present invention ultrasonic technology is applied for the measurement of fluid, such as gas, liquid or combination of these, flowing through the socket joint 1. The basic principle of the measurement is always the same, i.e. the propagation of ultrasonic through fluid in motion. The measurement can be realized in many different ways, which in particular are based on: Doppler effect, ultrasonic propagation velocity differences, ultrasonic beam drift and cross correlation technics. The transit time flowmeters can be divided into two different groups: direct transit time and differential transit time meters. For example, the flow velocity in time of flight method is

$$v = \frac{Δ t {c}^{2}}{2 L}$$

where c=sound velocity in medium, Δt=time of flight time difference in flow against downstream and upstream ultrasonic pulse, and L=length of ultrasonic pulse path.

In the ultrasonic measurement the scattering can be used to define turbidity of the measured fluid, the attenuation can be used to define possible accumulation of dirt and other contaminants on the inner surface of the measurement area over time, and absolute travel time can be used to define the temperature of the fluid, for example.

The finished socket joint 1 also preferably comprises an antenna 6 for transmitting the collected measurement results for further analysis. The antenna 6 is preferably connected to the socket joint 1 with wiring 7, so that it can be located at a distance from the actual pipeline, such as on ground surface in cases where the pipeline is dug underground for example, so that the data can be forwarded efficiently. Further, the required power source (not shown) for the ultrasonic transducers 2 and 3 is also connected to the socket join 1 via wiring, so that it is easily accessible and replaceable without actual access to the pipeline itself.

The other required electronics for carrying out the measurements and connected to the ultrasonic transducers 2 and 3, such as the measurement electronics and microcontroller unit (MCU) are not shown in the embodiment of FIG. 1, but these can be integrated in the socket joint 1 itself (with suitably formed channel and spaces), on the outer surface of the socket joint, close to the socket joint 1, or in with the antenna 6, for example. The cable length in between the socket joint and other required electronics should be short enough (approximately under 2 meters), so that this distance does not affect the actual measurement and the related processing phase negatively.

The specific exemplifying embodiments of the invention shown in figures and discussed above should not be construed as limiting. A person skilled in the art can amend and modify the embodiments described in many evident ways within the scope of the attached claims. Thus, the invention is not limited merely to the embodiments described above.

1. A method for manufacturing a pipe for a pipeline, wherein at least part of the pipe is manufactured by additive manufacturing process, and the method comprises:
forming inside material of the pipe at least one space for an ultrasonic transducer during the additive manufacturing process;
interrupting the additive manufacturing process before said at least one space is closed;
inserting the ultrasonic transducer in the at least one space; and continuing the additive manufacturing process for manufacturing the pipe, wherein continued additive manufacturing process covers the space.

2. The method according to claim 1, wherein the at least one space for the ultrasonic transducer is covered with a lid after inserting to the ultrasonic transducer and before continuing the additive manufacturing process.

3. The method according to claim 1, wherein two longitudinally displaced spaces are formed along the length of the pipe for two ultrasonic transducers.

4. The method according to claim 1, wherein at least one acoustic reflector is formed in an inner surface of the pipe with the additive manufacturing process of the pipe.

5. The method according to claim 1, wherein the material of the pipe is metal.

6. The method according to claim 1, wherein the additive manufacturing process is powder bed fusion process.

7. A pipe for a pipeline, comprising an inner surface and an outer surface, wherein said pipe is manufactured with an additive manufacturing process and comprises at least one ultrasonic transducer embedded inside material of the pipe during the additive manufacturing process.

8. The pipe according to claim 7, wherein the pipe comprises two ultrasonic transducers embedded inside the material of the pipe.

9. The pipe according to claim 7, wherein the pipe comprises at least one acoustic reflector formed from the material of the pipe on the inner surface of the pipe.

10. The pipe according to claim 9, wherein the at least one acoustic reflector is located at least partially in a recess of the inner surface of the pipe.

11. The pipe according to claim 7, wherein the pipe comprises data transmitting means for transmitting data from the at least one ultrasonic transducer or controlling means for controlling the at least one ultrasonic transducer or both.

12. The method according to claim 5, wherein the material of the pipe is steel.

13. The method according to claim 12, wherein the steel is AISI 316L steel.

14. The method according to claim 6, wherein the power bed fusion process is selected from the group consisting of direct metal laser sintering (DMLS), selective laser melting (SLM) and selective laser sintering (SLS).
